(19) United States
(12) Patent Application Publication
(10) Pub. No.: US 2012/0223537 A1
(43) Pub. Date: Sep. 6, 2012

(54) Excrements cleaning device

(76) Inventors: Mei Yu Yip, Hong Kong (CN); Tin Po Yip, Hong Kong (CN)

(21) Appl. No.: 13/122,393

(22) PCT Filed: Nov. 1, 2010
(86) PCT No.: PCT/CN10/78309

§ 371 Date: Apr. 1, 2011

(30) Foreign Application Priority Data
Nov. 25, 2009 (CN) 2009202606542

(51) Int. Cl. A01K 29/00

(52) U.S. Cl. 294/1.5; 294/1.3

(57) ABSTRACT

An excrements cleaning device, includes a cleaning bag, a cleaning supporting unit, and a cleaning bag releasing unit. The cleaning supporting unit includes an upper cover, a lower cover, and an opening elastic verge ring. The upper cover and the lower cover are pressed tightly and assembled fixedly to form a groove for receiving the opening elastic verge ring. The bag mouth is clamped between the groove and the opening elastic verge ring. An opening groove for moving the cleaning bag releasing unit back and forth is formed on a stern of the upper cover. A tensioning locking position and a releasing locking position are formed on a front part and a rear part of the opening groove.

### BACKGROUND OF THE PRESENT INVENTION

1. Field of Invention

The present invention relates to an excrements cleaning device which is portable.

2. Description of Related Arts

With the current high tempo, people tend to keep pets in order to relieve the pressure of work and life, and every day people can walk with their pets in the morning and evening. However, there is a big problem to the pets owners, how to clean the excrements of the pets in time in public? People usually use newspapers and other materials to pick up the smelly excrements which are relieved on the ground with their hands closely and throw that into a garbage can beside the street. This action is neither convenient nor sanitary and may bring troubles to the olds and the people who can barely walk.

### SUMMARY OF THE PRESENT INVENTION

In order to overcome the above disadvantages, the present invention is to provide an excrements cleaning device which is both sanitary and portable.

Accordingly, in order to accomplish the above objects, the present invention provides an excrements cleaning device, comprising:

a cleaning bag, which has a bag mouth;

a cleaning bag supporting unit, having a front end and a rear end, wherein the front end is in a frame structure for supporting the cleaning bag, the rear end is in a shape of a hollow grip, the cleaning bag supporting unit comprises an upper cover, a lower cover and an opening elastic verge ring, wherein the upper cover and the lower cover are pressed tightly and assembled fixedly to form a groove for receiving the opening elastic verge ring, the bag mouth is clamped between the groove and the opening elastic verge ring;

a handle, a long arm external casing pipe and an internal casing pipe, wherein a first end of the long arm external casing pipe is connected to the handle fixedly, a second end of the long arm external casing pipe is inserted moveably into a first end of the internal casing pipe, in such a manner that the long arm external casing pipe slides back and forth, a second end of the internal casing pipe is fixedly connected to the hollow grip of the rear end of the cleaning bag supporting unit; and

a cleaning bag releasing unit, which is connected to two ends of the opening elastic verge ring, wherein an opening groove for moving the cleaning bag releasing unit back and forth is formed on a tail of the upper cover, a tensioning locking position and a releasing locking position are respectively formed on a front part and a rear part of the opening groove which act on the opening elastic verge ring, the cleaning bag releasing unit comprises a holder which has a front end and a rear end, the front end of the holder is connected to the two ends of the opening elastic verge ring, a connecting shaft is provided on the rear end of the holder to couple with a manual casing pipe which rotates freely, a wrench is formed on the manual casing pipe, a first end of the connecting shaft is fixed by a braking ring.

Therefore, before dogs and other pets relieve the excrements, the bag mouth is clamped and fixed between the groove of the cleaning bag supporting frame and the opening elastic verge ring, people only need to hand the handle and stretch out the bag mouth to a place where the excrements drop. After relieving, the device is moved to the garbage can, the wrench of the cleaning bag releasing device is moved out of the tensioning locking position, then the cleaning bag with excrements is released. During this process, people don't contact the excrements with their hands, which is so convenient and sanitary that a route transmission of infectious diseases is cut off. To the patients who are completely bedridden, nursing staff can use the device to clean the excrements of the patients which would lighten their workload greatly.

These and other objectives, features, and advantages of the present invention will become apparent from the following detailed description, the accompanying drawings, and the appended claims.

### BRIEF DESCRIPTION OF THE DRAWINGS

FIG. 1 is a top sketch view of an excrements cleaning device according to a preferred embodiment of the present invention.

FIG. 2 is a sketch view of an upper cover of the excrements cleaning device according to the above preferred embodiment of the present invention.

FIG. 3 is a sketch view of a lower cover of the excrements cleaning device according to the above preferred embodiment of the present invention.

FIG. 4 is a schematic view of connecting a cleaning bag releasing unit and an opening elastic verge ring of the excrements cleaning device according to the above preferred embodiment of the present invention.

FIG. 5 is an enlarged sketch view of the cleaning bag releasing unit of the excrements cleaning device.

### DETAILED DESCRIPTION OF THE PREFERRED EMBODIMENT

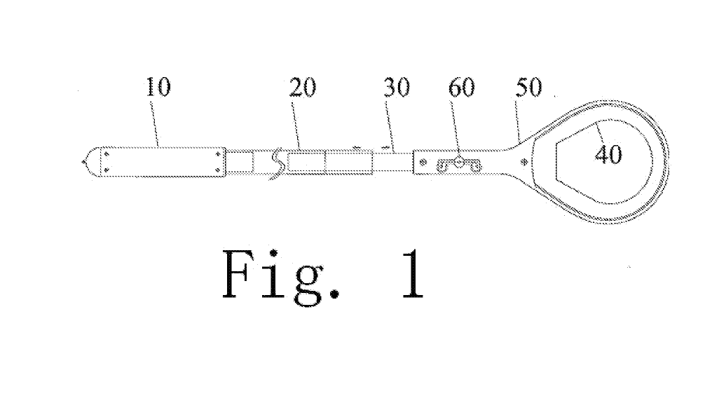

Referring to FIG. 1 of the drawings, an excrements cleaning device according to a preferred embodiment of the present invention is illustrated, comprising:

a cleaning bag 40, which has a bag mouth;

a cleaning bag supporting unit 50, having a front end and a rear end, wherein the front end is in a frame structure for supporting the cleaning bag 40, the rear end is in a shape of a hollow grip, the cleaning bag supporting unit 50 comprises an upper cover 51, a lower cover 52 and an opening elastic verge ring 53, wherein the upper cover 51 and the lower cover 52 are pressed tightly and assembled fixedly to form a groove for receiving the opening elastic verge ring 53, the bag mouth is clamped between the groove and the opening elastic verge ring 53, and

a cleaning bag releasing unit 60, connected to two ends of said opening elastic verge ring 53, wherein an opening groove 5101 for moving said cleaning bag releasing unit 60 back and forth is formed on a tail of said upper cover 51, a tensioning locking position 5102 and a releasing locking position 5103 are respectively formed on a front part and a rear part of said opening groove 5101 which act on said opening elastic verge ring 53.

The excrements cleaning device further comprises a handle 10, a long arm external casing pipe 20 and an internal casing pipe 30, a first end of the long arm external casing pipe 20 is connected to the handle 10 fixedly, a second end of the long arm external casing pipe 20 is inserted moveably by a first end of the internal casing pipe 30, in such a manner that the long arm external casing pipe 20 slides back and forth to elongate or shorten, which is convenient for operating from a long or near distance; and

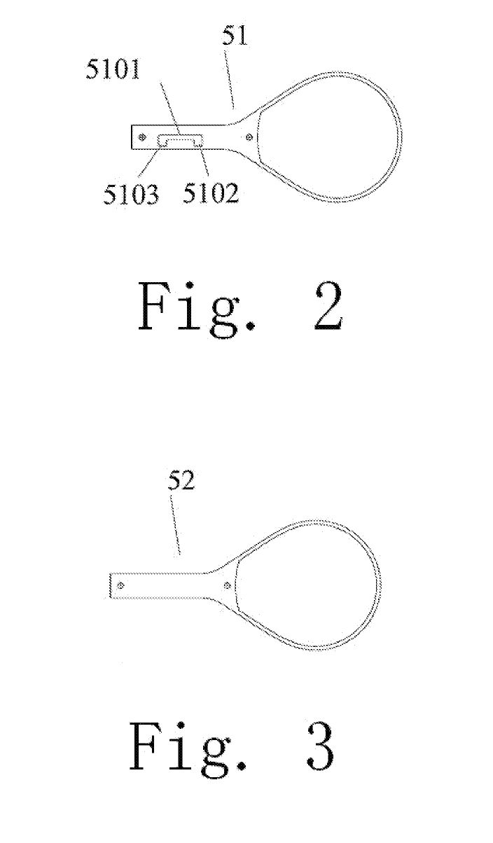

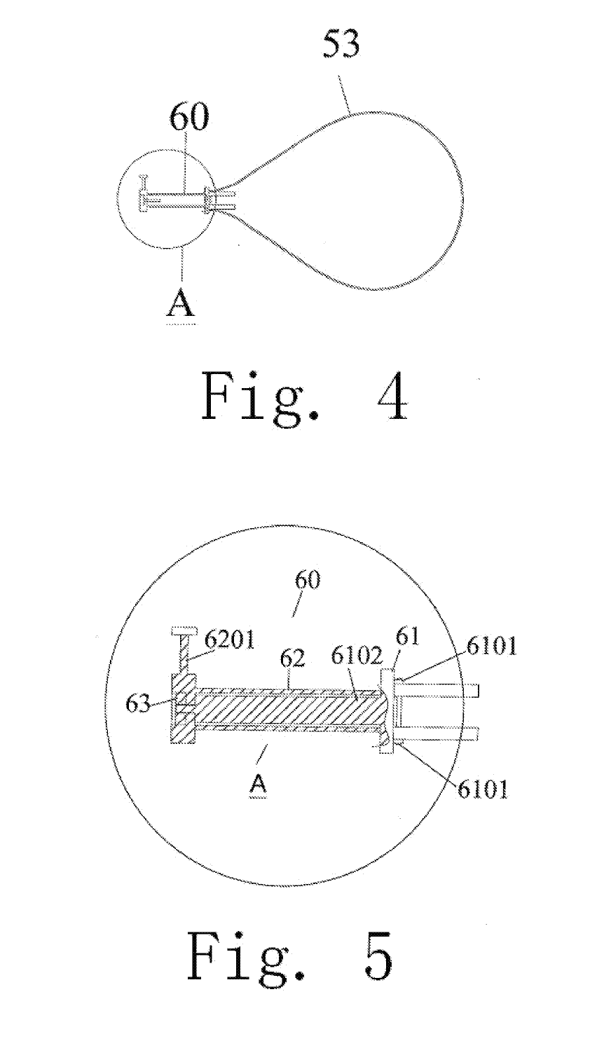

Referring to FIG. 2-4 of the drawings, an upper cover 51, a lower cover 52 and an opening elastic verge ring 53 are illustrated. The cleaning bag supporting unit 50 comprises an upper cover 51, a lower cover 52 and an opening elastic verge ring 53, wherein the upper cover 51 and the lower cover 52 are pressed tightly and assembled fixedly to form a groove for receiving the opening elastic verge ring 53, the bag mouth is clamped between the groove and the opening elastic verge ring 53. And a cleaning bag releasing unit 60 is connected to two ends of the opening elastic verge ring 53, an opening groove 5101 for moving the cleaning bag releasing unit back and forth is formed on a tail of the upper cover 51, a tensioning locking position 5102 and a releasing locking position 5103 are respectively formed on a front part and a rear part of the opening groove 5101 which act on the opening elastic verge ring 53.

Referring to FIG. 5 of the drawings, the cleaning bag releasing unit 60 comprises a holder 61 which has a front end 6101 connecting to the two ends of the opening elastic verge ring 53, a connecting shaft 6102 is provided on a rear end which is coupled with a manual casing pipe 62 rotating freely, a wrench 6201 is formed on the manual casing pipe 62, a first end of the connecting shaft 6102 is fixed by a braking ring 63.

An operating process for the above excrements cleaning device comprises the steps of:

installing the cleaning bag 40, comprising: upwardly pulling the wrench 6201 of the cleaning bag releasing unit 60 to the releasing locking position 5103, clinging an edge of the bag mouth from bottom to top to a periphery of the groove formed by pressing tightly and assembling fixedly the upper cover 51 and the lower cover 52, and moving the wrench 6201 to the tensioning locking position 5102 along the opening groove 5101 of the upper cover 51, so the opening elastic verge ring 53 is clamped between the groove formed by pressing tightly and assembling fixedly the upper cover 51 and the lower cover 52, and the opening elastic verge ring 53, the cleaning bag 40 will not drop; and

releasing the cleaning bag 40, comprising: adjusting the distance between the long arm external casing pipe 20 and the internal casing pipe 30 as required, handling the handle 10 and putting the cleaning bag 40 precisely to the place the excrements will fall, so that the excrements are received, then putting the excrements cleaning device to the garbage can and moving away the wrench 6201 of the cleaning bag releasing unit 60 out of the tensioning locking position 5102, the cleaning bag with excrements will fall easily, wherein during this action, the hands of a user will not contact the excrements which is convenient and sanitary that a route transmission of infectious diseases is cut off, to the patients who are completely bedridden, nursing staff can use the excrements cleaning device to clean the excrements of the patients which will lighten their workload greatly.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. an excrements cleaning device, comprising:
a cleaning bag, which has a bag mouth;
a cleaning bag supporting unit, having a front end that is in a frame structure for supporting said cleaning bag and a rear end that is in a shape of a hollow grip, comprising an upper cover, a lower cover and an opening elastic verge ring, wherein said upper cover and said lower cover are pressed tightly and assembled fixedly to form a groove for receiving said opening elastic verge ring, said bag mouth is clamped between said groove and said opening elastic verge ring; and
a cleaning bag releasing unit, connected to two ends of said opening elastic verge ring, wherein an opening groove for moving said cleaning bag releasing unit back and forth is formed on a tail of said upper cover, a tensioning locking position and a releasing locking position are respectively formed on a front part and a rear part of said opening groove which act on said opening elastic verge ring.

2. The excrements cleaning device, as recited in claim 1, further comprising a handle, a long arm external casing pipe and an internal casing pipe, wherein a first end of said long arm external casing pipe is connected to said handle fixedly, a second end of said long arm external casing pipe is inserted moveably into a first end of said internal casing pipe, in such a manner that said long arm external casing pipe slides back and forth, a second end of said internal casing pipe is fixedly connected to said hollow grip of said rear end of said cleaning bag supporting unit.

3. The excrements cleaning device, as recited in claim 1, wherein said cleaning bag releasing unit comprises a holder which has a front end and a rear end, said front end of said holder is connected to said two ends of said opening elastic verge ring, wherein a connecting shaft is provided on said rear end of said holder to couple with a manual casing pipe which rotates freely, a wrench is formed on said manual casing pipe, a first end of said connecting shaft is fixed by a braking ring.

4. The excrements cleaning device, as recited in claim 2, wherein said cleaning bag releasing unit comprises a holder which has a front end and a rear end, said front end of said holder is connected to said two ends of said opening elastic verge ring, wherein a connecting shaft is provided on said rear end of said holder to couple with a manual casing pipe which rotates freely, a wrench is formed on said manual casing pipe, a first end of said connecting shaft is fixed by a braking ring.
